(19) United States
(12) Patent Application Publication
(10) Pub. No.: US 2026/0230367 A1
(43) Pub. Date: Aug. 6, 2026

(54) TRANSMITTING DATA TO A NETWORK NODE, AND RECEIVING DATA FROM A NETWORK NODE USING GRASSMANN CONSTELLATIONS

(71) Applicant: Telefonaktiebolaget LM Ericsson (publ), Stockholm (SE)

(72) Inventors: Naoki ENDO, Hiratuka-shi, Kanagawa (JP); Naoki ISHIKAWA, Yokohama, Kanagawa (JP); Hiroki IIMORI, Yokohama-shiKanagawa (JP); Chandan PRADHAN, Yokohama, Kanagawa (JP); Szabolcs MALOMSOKY, Yokohama, Kanagawa (JP)

(73) Assignee: Telefonaktiebolaget LM Ericsson (publ), Stockholm (SE)

(21) Appl. No.: 19/150,766

(22) PCT Filed: Jan. 25, 2023
(86) PCT No.: PCT/SE2023/050066

§ 371 Date: Jul. 24, 2025

(51) Int. Cl. H04L 27/34; H04L 27/26; H04W 72/0446

(52) U.S. Cl. CPC H04L 27/3483; H04L 27/2613; H04W 72/0446

(57) ABSTRACT

Methods and apparatus are provided. In an example, a method of transmitting data to a network node is provided. The method comprises selecting, based on the data to be transmitted to the network node, one of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum. The method also comprises transmitting the selected reference signal symbol sequences to the network node.

### TECHNICAL FIELD

Example embodiments of this disclosure relate to transmitting data to a network node, and/or receiving data from a network node, such as for example reference signal symbol sequences.

### BACKGROUND

Demand for wireless communication, such as for example according to the 5th Generation (5G) standard and beyond, has continued to grow, resulting in the fact that under the limited radio spectrum, communication technologies that can achieve high spectral efficiency while reducing computational complexity and energy usage will become more important.

In some examples of wireless communication, channel information (a.k.a. Channel State Information, CSI) is required for a receiver to detect data sequences transmitted from UEs. The accuracy of CSI impacts the overall performance of data transmission, e.g., spectrum efficiency. In order to obtain the CSI between a base station and a UE, a reference-signal-based training method has been used. In such scenarios, a UE transmits pilot (i.e., reference) symbols known by both transmitter and receiver, based on which the receiver estimates CSI. Although such training methods result in reliable and high accurate channel estimation, the associated pilot overhead leads to degradation in the overall spectrum efficiency.

To reduce the pilot overhead and improve the spectral efficiency, a number of methods have been proposed, such as a pilot-imposed approach that transmits pilot and data simultaneously by simply adding a pilot signal onto the data signal and transmitting its combination within the same time and frequency resource block. However, such a superimposed pilot approach is limited in terms of the channel estimation accuracy.

New Radio (NR) uses CP-OFDM (Cyclic Prefix Orthogonal Frequency Division Multiplexing) in both downlink (DL) (i.e. from a network node, gNB, or base station, to a user equipment or UE) and uplink (UL) (i.e. from UE to gNB). Discrete Fourier Transform (DFT) spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols. Data scheduling in NR is typically on a slot basis. An example of NR time-domain structure with 15 kHz subcarrier spacing is shown in FIG. 1 with a 14-symbol slot, where the first two symbols contain physical downlink control channel (PDCCH) and the rest contains a physical shared data channel, either PDSCH (physical downlink shared channel) or PUSCH (physical uplink shared channel).

Different subcarrier spacing values are supported in NR. The supported subcarrier spacing values (also referred to as different numerologies) are given by Δf=(15×2^{μ}) kHz, where μ={0,1,2,3,4}. Δf=15 kHz is the basic subcarrier spacing. The slot duration at different subcarrier spacings is given by

$$\frac{1}{{2}^{μ}} ms .$$

In the frequency domain, a system bandwidth is divided into resource blocks (RBs), each corresponds to 12 contiguous subcarriers. The RBs are numbered starting with 0 from one end of the system bandwidth. An example of the NR physical time-frequency resource grid is illustrated in FIG. 2, where only one resource block (RB) within a 14-symbol slot is shown. One OFDM subcarrier during one OFDM symbol interval forms one resource element (RE).

In NR Rel-15, uplink data transmission can be dynamically scheduled using PDCCH. A UE first decodes uplink grants in PDCCH and then transmits data over PUSCH based on the decoded control information in the uplink grant such as modulation order, coding rate, uplink resource allocation, etc.

Demodulation Reference Signal (DM-RS) for PUSCH is an UL reference signal that consists of a pseudo-random QPSK sequence for CP-OFDM or low peak to average power ratio (PAPR) sequences for DFT-S-OFDM. DM-RS is used for demodulating of PUSCH such that the receiver (i.e., the gNB) can handle time-varying and frequency-selective channels. DM-RS is confined to the scheduled PUSCH bandwidth and duration.

The mapping of DM-RS to REs is configurable in both frequency and time domain. In the frequency domain, there are two mapping types: type 1 (comb based) or type 2 (non-comb based). In the time-domain, DM-RS can be either single symbol or double symbol, where the latter means that DM-RS is mapped in pairs of two adjacent symbols. Furthermore, a UE can be configured with one, two, three or four single-symbol DM-RS and one or two double-symbol DM-RS. In low-Doppler scenarios, one DM-RS symbol may be sufficient whereas in high-Doppler scenarios, additional DM-RS symbols may be required.

The frequency-domain starting position of DM-RS is the same as the frequency-domain starting position of PUSCH. The time-domain starting position of DM-RS depends on the PUSCH mapping type:
For PUSCH mapping type A (slot-based scheduling), the first DM-RS symbol is in the third or fourth symbol (i.e., symbol 2 or 3) of a slot, configured by higher-layer parameter DM-RS-TypeA-Position in the Master Information Block (MIB) broadcast by the gNB.
For PUSCH mapping type B (non-slot-based scheduling), the first DM-RS symbol of a slot is the same as the first PUSCH symbol of a slot.

DM-RS for PUSCH is Radio Resource Control (RRC) configured through the DM-RS-UplinkConfig Information Element (IE), for PUSCH scheduled by Downlink Control Information (DCI) format 0_1 or DCI format 0_2. DM-RS for PUSCH is configured in RRC according to 3GPP TS 38.331 version 16.1.0.

DM-RS for PUSCH is configurable with respect to:
The DM-RS frequency-domain mapping type (type 1 or type 2), configured by the RRC parameter DM-RS-Type. Type 1 is comb based with 2 code division multiplexed (CDM) groups, whereas type 2 is not comb based with 3 CDM groups. For DFT-S-OFDM, only type 1 is supported. FIG. 3 illustrates the symbol positions of DM-RS symbols in a resource block for the two DM-RS types 1 and 2. Specifically, FIG. 3(a) illustrates DM-RS symbol positions for DM-RS type 1 single symbol; FIG. 3(b) illustrates DM-RS symbol positions for DM-RS type 1 double symbol; FIG. 3(c) illustrates DM-RS symbol positions for DM-RS type 2 single symbol; and FIG. 3(d) illustrates DM-RS symbol positions for DM-RS type 2 double symbol. In these FIGS. 3(a)-(d), a shaded resource element indicates that a DM-RS symbol is transmitted within that resource element. Note that there are multiple DM-RS ports per CDM group, which are separated using frequency-domain (and time-domain, for double-symbol DM-RS) Orthogonal Cover Codes (OCCs):
   For single-symbol DM-RS, there exist 4 and 6 orthogonal DM-RS ports (2 DM-RS ports per CDM group, separated using a length-2 frequency domain orthogonal cover code, FD-OCC) for type 1 and type 2, respectively.
   For double-symbol DM-RS, there exist 8 and 12 orthogonal DM-RS ports (4 DM-RS ports per CDM group, separated using a length-2 Frequency Domain Orthogonal Cover Code (FD-OCC) combined with a length-2 Time Domain Orthogonal Cover Code (TD-OCC)) for type 1 and type 2, respectively.
Any additional DM-RS symbols (0, 1, 2 or 3 for single-symbol DM-RS and 0 or 1 for double-symbol DM-RS) are configured by the RRC parameter DM-RS-AdditionalPosition. The position of additional DM-RS depends on the PUSCH mapping type and PUSCH duration according to a predefined table. Note that it is not possible to configure a TD-OCC over additional (i.e., noncontiguous DM-RS. FIG. 4 illustrates an example of symbol positions of DM-RS symbols in a resource block for DM-RS type 1 with additional DM-RS symbols. Specifically, FIG. 4(a) shows DM-RS symbol positions for DM-RS type 1, single symbol, with two additional DM-RS symbols, and FIG. 4(b) shows DM-RS symbol positions for DM-RS type 1, double symbol, with one additional DM-RS symbol.
The associated Phase Tracking Reference Signal (PT-RS) (if any) may be configured by the RRC parameter phase TrackingRS.
The maximum number of adjacent DM-RS symbols (1 or 2) may be configured by the RRC parameter maxLength.

If transform precoding is disabled (i.e., if the waveform is CP-OFDM), DM-RS for PUSCH can be additionally and optionally configured with respect to scrambling ID 0 and 1, configured by RRC parameters scramblingID0 and scramblingID1, respectively, which are used for generating the pseudo-random DM-RS sequence.

DM-RS ports are mapped to resource elements within one CDM group. DM-RS ports that belong to the same CDM group are separated by a length-2 FD-OCC (and a length-2 TD-OCC, for double-symbol DM-RS). In NR Rel-16, the DM-RS sequence is mapped to the following subcarriers (for DFT-S-OFDM, only DM-RS type 1 is supported):

$$k = \{ \begin{matrix}4 n + 2 {k}^{′} + Δ , & for type 1 , \\ 6 n + {k}^{′} + Δ , & for type 2.\end{matrix}$$

Here, k is the subcarrier index (which starts/ends at the first/last subcarrier within the scheduled PUSCH bandwidth), n∈{0,1,2, . . . }, k′∈{0,1}, and Δ is an offset that depends on the CDM group.

5 In Table 1 and Table 2, we show port-specific parameters for DM-RS type 1 and type 2. Here, w_{f}(k′), where k′∈{0,1}, is the FD-OCC and wₜ(l′), where l′=0 for single-symbol DM-RS and l′∈{0,1} for double-symbol DM-RS, is the TD-OCC. Note that DM-RS ports in different CDM groups are separated by different offsets and that DM-RS ports within the same CDM group are separated through coding.

TABLE 1
Parameters for PUSCH DM-RS configuration type 1
(reproduced from Table 6.4.1.1.3-1 of 3GPP TS 38.211).
Here, \tilde{p} denotes the DM-RS port.

| | | |
|---|---|---|
| CDM | w_{f} (k′) | wₜ (l′) |

| \tilde{p} | group λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 2
Parameters for PUSCH DM-RS configuration type 2
(reproduced from Table 6.4.1.1.3-2 of 3GPP TS 38.211).
Here, \tilde{p} denotes the DM-RS port.

| | | |
|---|---|---|
| CDM | w_{f} (k′) | wₜ (l′) |

| \tilde{p} | group λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

From the transmitter's perspective, the number of DM-RS ports used for PUSCH transmission coincides with the transmission rank, i.e., one DM-RS port per transmitted layer. The DM-RS port mapping is signaled to the UE from the gNB via DCI. Tables 3 and 4 below show such an indication for DCI 0_1, CP-OFDM, single-symbol DM-RS type 1, and for transmission rank 1 and 2, respectively. Similar tables can be found in 3GPP TS 38.212 version 16.10.0 for rank 3 and 4, double-symbol DM-RS, and for DM-RS type 2. Subcarriers, which are associated with a CDM group, that are not used for DM-RS can be used for PUSCH. After layer mapping, the DM-RS and the associated PUSCH are mapped to physical antennas through precoding.

TABLE 3
Antenna ports for single-symbol DM-RS type 1, transform
precoding is disabled, rank-1 transmission (reproduced
from Table 7.3.1.1.2-8 of 3GPP 38.212 version 16.10.0).

| | Number of DM-RS CDM group(s) | DM-RS |
|---|---|---|
| Value | without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

TABLE 4
Antenna ports for single-symbol DM-RS type 1, transform
precoding is disabled, rank-2 transmission (reproduced
from Table 7.3.1.1.2-9 of 3GPP 38.212 version 16.10.0).

| | Number of DM-RS CDM group(s) | DM-RS |
|---|---|---|
| Value | without data | port(s) |
| 0 | 1 | 0, 1 |
| 1 | 2 | 0, 1 |
| 2 | 2 | 2, 3 |
| 3 | 2 | 0, 2 |
| 4-7 | Reserved | Reserved |

The training methods referred to above have been adopted in typical wireless communications standards. Its spectrum efficiency inevitably becomes worse for high-mobility scenarios due to the fact that more reference symbols are needed to track and estimate the varying channel accurately, which increases the communication overhead. This calls for need to find methods to eliminate or reduce overhead due to use of reference symbols, to achieve higher spectral efficiency for 5G-advanced and beyond.

An approach to tackle the pilot overhead is the use of differential space-time coding, which does not require periodic pilot symbols and supports the scenarios where CSI fluctuates rapidly over time. It enables noncoherent detection by encoding the information onto the signal difference between time slots. Its major issue is that one needs to concede a 3 dB SNR loss at best and a low spectrum efficiency due to the nature of the differential coding.

Semi-blind methods have been proposed to reduce pilot overheads. Semi-blind approaches first estimate the CSI roughly by using a short reference signal sequence and intend to improve the CSI by taking advantage of the data and performing joint channel and data detection. Although this approach improves the spectrum efficiency compared to coherent counterparts, transmitting a reference signal still limits the improvement on the spectrum efficiency.

Another approach estimates CSI by using second order statistics of received signals and algebraic properties of the symbol. The major problem of this method is that it is difficult to determine the phase of the channel response in the complex domain, resulting in inferior channel estimation performance. To resolve this issue, it is needed to transmit a pilot tuple or use an asymmetric constellation. This uses Orthogonal Space-Time Block Coding (OSTBC) symbols and estimates CSI from a covariance matrix of the received signal, which requires a long coherence time to obtain CSI, leading to a significant amount of latency.

Finally, some approaches superimpose pilot symbols onto data symbols on the complex domain. This enables simultaneous estimation of channel and data at the receiver. In massive MIMO scenarios, the superimposed pilot is effective in mitigating pilot contamination in both uplink and downlink. However, this method deteriorates the spectrum efficiency as the transmit power that is allocated to data symbols decreases.

Overall, the above approaches are shown to be limited [1] in terms of either channel estimation performance or spectrum efficiency, while being incompatible with the 3GPP standard signaling structure.

### SUMMARY

Examples of this disclosure may have certain advantages. For example, embodiments of this disclosure may improve channel estimation performance while ensuring symbol error rate (SER) performance is not affected or significantly affected.

One aspect of the present disclosure provides a method of transmitting data to a network node. The method comprises selecting, based on the data to be transmitted to the network node, one of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum. The method also comprises transmitting the selected reference signal symbol sequences to the network node.

Another aspect of the present disclosure provides a method of receiving data from a network node. The method comprises receiving, from the network node, a reference signal symbol sequence of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum. The method also comprises determining, based on the reference signal symbol sequence, the data transmitted by the network node.

Another aspect of the present disclosure provides a method of determining a plurality of reference signal symbol sequences. The method comprises selecting a plurality of reference signal symbol sequences, wherein the first reference signal symbol sequences correspond to constellation points on a Grassmannian manifold. The method also comprises selecting a phase for at least a subset of the reference signal symbol sequences to increase a sum of inner products of pairs of the reference signal symbol sequences in at least a subset of the reference signal symbol sequences.

An additional aspect of the present disclosure provides apparatus for transmitting data to a network node. The apparatus comprises a processor and a memory. The memory contains instructions executable by the processor such that the apparatus is operable to select, based on the data to be transmitted to the network node, one of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum; and transmit the selected reference signal symbol sequences to the network node.

A further aspect of the present disclosure provides apparatus for receiving data from a network node. The apparatus comprising a processor and a memory. The memory contains instructions executable by the processor such that the apparatus is operable to receive, from the network node, a reference signal symbol sequence of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum; and determine, based on the reference signal symbol sequence, the data transmitted by the network node.

A further aspect of the present disclosure provides apparatus for determining a plurality of reference signal symbol sequences. The apparatus comprising a processor and a memory. The memory contains instructions executable by the processor such that the apparatus is operable to select a plurality of reference signal symbol sequences, wherein the first reference signal symbol sequences correspond to constellation points on a Grassmannian manifold, and select a phase for at least a subset of the reference signal symbol sequences to increase a sum of inner products of pairs of the reference signal symbol sequences in at least a subset of the reference signal symbol sequences.

A still further aspect of the present disclosure provides apparatus for transmitting data to a network node. The apparatus is configured to select, based on the data to be transmitted to the network node, one of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum; and transmit the selected reference signal symbol sequences to the network node.

Another aspect of the present disclosure provides apparatus for receiving data from a network node. The apparatus is configured to receive, from the network node, a reference signal symbol sequence of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum; and determine, based on the reference signal symbol sequence, the data transmitted by the network node.

An additional aspect of the present disclosure provides apparatus for determining a plurality of reference signal symbol sequences. The apparatus is configured to select a plurality of reference signal symbol sequences, wherein the first reference signal symbol sequences correspond to constellation points on a Grassmannian manifold, and select a phase for at least a subset of the reference signal symbol sequences to increase a sum of inner products of pairs of the reference signal symbol sequences in at least a subset of the reference signal symbol sequences.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 illustrates an example of a NR time-domain structure with 15 kHz subcarrier spacing;

FIG. 2 illustrates an example of a NR physical time-frequency resource grid;

FIG. 3 illustrates the symbol positions of DM-RS symbols in a resource block for DM-RS types 1 and 2;

FIG. 4 illustrates an example of symbol positions of DM-RS symbols in a resource block for DM-RS type 1 with additional DM-RS symbols;

FIG. 5 is a flow chart of an example of a method of transmitting data to a network node;

FIG. 6 is a flow chart of an example of a method of receiving data from a network node;

FIG. 7 shows examples of a single symbol and a double symbol Type 1 Grassmann DM-RS;

FIG. 8 shows an example of repetition of a Grassmann based DM-RS sequence in the frequency domain;

FIG. 9 shows examples of a Grassmann based DM-RS sequence divided into groups for a DM-RS port while utilizing consecutive OFDM symbols;

FIG. 10 shows examples of use of both legacy DM-RS and DM-RS according to this disclosure;

FIG. 11 shows an example of normalized mean square error (NMSE) performance of different Grassmann constellations when used for data transmission;

FIG. 12 shows an example of symbol error rate (SER) performance of different Grassmann constellations when used for data transmission;

FIG. 13 is a flow chart of an example of a method of determining a plurality of reference signal symbol sequences;

FIG. 14 shows a scatter plot of examples of the inner product of different Grassmann codeword pairs for the case of a non-phase-aligned Grassmann constellation;

FIG. 15 shows a scatter plot of examples of the inner product of different Grassmann codeword pairs for the case of a phase-aligned ManOpt Grassmann constellation;

FIG. 16 shows another example of normalized mean square error (NMSE) performance of different Grassmann constellations when used for data transmission;

FIG. 17 shows another example of symbol error rate (SER) performance of different Grassmann constellations when used for data transmission;

FIG. 18 is a schematic of an example of an apparatus 1800 for transmitting data to a network node;

FIG. 19 is a schematic of an example of an apparatus 1900 for receiving data from a network node; and

FIG. 20 is a schematic of an example of an apparatus 2000 for determining a plurality of reference signal symbol sequences.

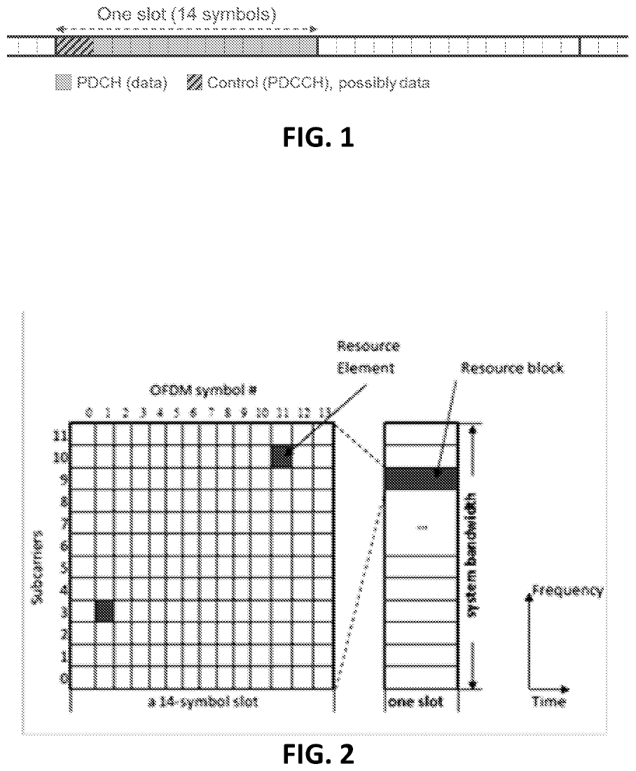

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

As indicated above, example embodiments of this disclosure may enable improvements on the spectrum efficiency by replacing reference signals (e.g., DM-RS in NR) with a codeword, such as for example from a Grassmann manifold, where each codeword can convey data bits. Example embodiments may also reduce the impact of overhead from reference signals such as DM-RS. This may be particularly beneficial in networks, such as for example 5G and 6G networks, that may have very small amounts of data to transmit, and as such the overhead due to reference signal symbols may be significant. It is assumed that in the future, networks may need be adapted for transmitting smaller chunks of data, such as can be carried by just one symbol of a resource block (RB). Therefore, it is particularly useful to reduce the impact of reference signals, such as in example methods of this disclosure that can transmit data with reference signal symbols.

FIG. 5 is a flow chart of an example of a method 500 of transmitting data to a network node. In some examples, the network node is a Radio Access Network (RAN) node, such as a base station, gNodeB, eNodeB, or similar. In such examples, the method 500 may be performed by a User Equipment (UE). Alternatively, in some examples, the network node is a UE, and the method 500 may be performed by a RAN node, such as a base station, gNodeB, eNodeB, or similar.

The method 500 comprises, in step 502, selecting, based on the data to be transmitted to the network node, one of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum. Step 504 of the method comprises transmitting the selected reference signal symbol sequences to the network node. In some examples, the transmitted selected reference signal symbol sequence may be a pilot signal or a demodulation reference signal (DM-RS), or another reference signal.

In some examples, each reference signal symbol sequence is associated with a different value for the data. Therefore, for example, transmission of the selected symbol sequence of reference signal symbols conveys data through the particular sequence that is selected. In particular examples, there are n reference signal symbols in the sequence, and the number of reference signal symbol sequences from which the transmitted reference signal symbols are selected is 2^{B} with B being the number of bits encoded within the reference signal symbol sequences. Selecting one of a plurality of reference signal symbol sequences in step 502 may in some examples comprise selecting a reference signal symbol sequence or constellation point from 28 reference signal symbol sequences and/or 2B constellation points, with B being the number of data bits encoded by each reference signal symbol sequence or constellation point.

The Grassmann manifold may in some examples be at least a 2n dimension manifold, where n is the number of reference signal symbols. Thus for example each reference signal symbol transmitted in step 504 may convey two dimensions of the constellation point on the Grassmann manifold.

The reference signal symbol sequence may in some examples be repeated, such as for example in the same resource block, slot, mini-slot, subframe and/or frame. The method 500 may therefore comprise transmitting the selected reference signal symbol sequence in a plurality of first resource elements, and repeating the reference signal symbols in a plurality of second resource elements. The first plurality of resource elements are within a first frequency range, and the second plurality of resource elements may be for example within a second frequency range non-overlapping with the first frequency range. The first and second plurality of resource elements may overlap in time, partially overlap, or be non-overlapping. The first resource elements and the second resource elements may for example be within a resource block, slot, mini-slot, subframe and/or frame.

In some examples, the selected reference signal symbol sequence may correspond to a first antenna port. In such examples, the method 500 may comprise, for each of one or more further antenna ports, transmitting a further reference signal symbol sequence to the network node (for example, in the same resource block, slot, mini-slot, subframe and/or frame as the plurality of reference signal symbols selected in step 502). The method 500 may also comprise, for each of the one or more further antenna ports, selecting the further reference signal symbol sequence based on respective further data to be transmitted to the network node. This may be selected in a manner similar to the reference signal symbol sequence selected in step 502 above, e.g. from a plurality of symbol sequences that correspond to constellation points on a Grassmann manifold. Alternatively, the further reference symbols may comprise legacy reference signal symbols for example.

The method 500 may also in some examples comprise transmitting additional reference signal symbols to the network node, wherein the additional reference signal symbols correspond to a legacy reference signal (for example, in the same resource block, slot, mini-slot, subframe and/or frame as the plurality of reference signal symbols selected in step 502). Thus, for example, a resource block, slot, mini-slot, subframe and/or frame may include both legacy reference signal symbols and reference signal symbols that convey data as selected in step 502 of the method 500.

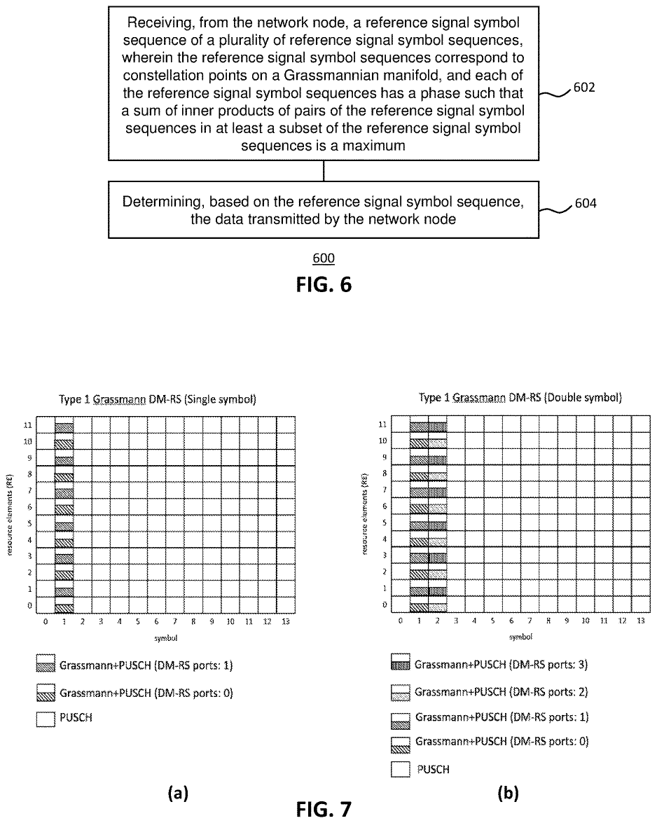

FIG. 6 is a flow chart of an example of a method 600 of receiving data from a network node. In some examples, the network node is a Radio Access Network (RAN) node, such as a base station, gNodeB, eNodeB, or similar. In such examples, the method 600 may be performed by a User Equipment (UE). Alternatively, in some examples, the network node is a UE, and the method 600 may be performed by a RAN node, such as a base station, gNodeB, eNodeB, or similar. In some examples, the network node from which the data is received performs the method 500 referred to above.

The method 600 comprises, in step 602, receiving, from the network node, a reference signal symbol sequence of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum. Step 604 of the method 600 comprises determining, based on the reference signal symbol sequence, the data transmitted by the network node. For example, each reference signal symbol sequence may be associated with a different value for the data.

In some examples, there may be at least 2^{B} different reference signal symbol sequences and/or at least 2^{B} constellation points, with B being the number of data bits encoded by each reference signal symbol sequence. In some examples, determining the data transmitted by the network node in step 604 may comprise determining that the plurality of reference signal symbols comprise one of the constellation points, wherein each constellation point represents a different reference signal symbol sequence and/or a different value for the data. Additionally or alternatively, in some examples, the Grassmann manifold is at least a 2n dimension manifold, where n is the number of reference signal symbols in each reference signal symbol sequence.

In some examples, determining the data transmitted by the network node comprises determining that the received reference signal symbol sequence corresponds to a codeword of a plurality of codewords in a codebook. Thus, for example, the data may be determined by matching the received reference signal symbol sequence to one of the codewords, and the transmitted data corresponds to the value for the data associated with the matched codeword.

The reference signal symbols may in some examples be repeated. The method 600 may therefore comprise receiving the reference signal symbols in a plurality of first resource elements, and receiving a repeat of the reference signal symbols in a plurality of second resource elements. The first plurality of resource elements are within a first frequency range, and the second plurality of resource elements may be for example within a second frequency range non-overlapping with the first frequency range. The first and second plurality of resource elements may overlap in time, partially overlap, or be non-overlapping. The first resource elements and the second resource elements may for example be within a resource block, slot, mini-slot, subframe and/or frame.

In some examples, the plurality of reference signal symbols correspond to a first antenna port. In such examples, the method 600 may comprise, for each of one or more further antenna ports, receiving a respective further reference signal symbol sequence from the network node (for example, in the same resource block, slot, mini-slot, subframe and/or frame as the plurality of reference signal symbols selected in step 502). The method 600 may also comprise, for each of the one or more further antenna ports, determining, based on the further reference signal symbol sequence, respective further data transmitted by the network node. This may be determined in a manner similar to step 604 of the method 600 described above, e.g. from a plurality of symbol sequences, from a plurality of constellation points, or from a plurality of constellation points on a Grassmann manifold. Alternatively, the further reference symbols may comprise legacy reference signal symbols for example.

The method 600 may also in some examples comprise receiving additional reference signal symbols from the network node, wherein the additional reference signal symbols correspond to a legacy reference signal (for example, in the same resource block, slot, mini-slot, subframe and/or frame as the plurality of reference signal symbols selected in step 502). Thus, for example, a resource block, slot, mini-slot, subframe and/or frame may include both legacy reference signal symbols, which do not convey data, and reference signal symbols that convey the data that is determined in step 604 of the method 600.

As indicated above, in examples of this disclosure a Grassmann constellation may be used to select symbols for a data-carrying DM-RS, for example in place of legacy DM-RS. A Grassmann manifold may be used to construct DM-RS symbols which can carry data on top of it compared to legacy DM-RS symbols. In some examples, the Grassmann-based DM-RS may be configured in a User Equipment by a network node (e.g. base station, eNodeB, gNodeB) through Radio Resource Control (RRC) signaling.

Particular examples based on use of a Grassmann manifold are now described, though the concepts described may also be applied to other examples that use other Grassmann-based constellations and/or symbol sequences.

Some Grassmann-based non-coherent transmission methodologies have been reported in which several multidimensional Grassmann constellations have been suggested. Despite such Grassmann constellation designs, utilizing a Grassmann constellation in place of a reference signal in 5G NR configuration has not been suggested in the prior art.

### Grassmann Manifold Based Transmission

Consider a UE with M antennas transmitting to a gNB with N antennas. Concatenating received signals over temporal length T, with T>M, the received signal model can be given by:

$$Y = XH + V , \qquad ( 1 )$$

where Y∈ [symbol] ^{T×N} is the received signal matrix, X∈ [symbol] ^{T×M} is the transmitted matrix constructed from a T-dimensional Grassmann manifold [1], H∈ [symbol] ^{M×N} is the effective channel matrix consisting of the precoding matrix, receiver filter, and fading channel matrix, and V∈ [symbol] ^{T×N} is the noise matrix. Next, a possible approach to estimate the transmitted matrix X and the channel matrix H is described.

### Estimation of the Transmitted Matrix X

In order to estimate the channel matrix, the transmitted matrix X is firstly estimated, where X is one of the discrete points represented by the pre-defined MT-dimensional Grassmann manifold. Although any reasonable detection methodology can be considered to detect the transmitted matrix X, a generalized likelihood ratio test (GLRT) is presented here, which is to solve the following maximization problem:

$$\hat{X} = {arg max}_{\dot{X} ∈ 𝒳} Tr \{ {YY}^{H} \dot{X} {\dot{X}}^{H} \} , \qquad ( 2 )$$

where \hat{X} is the estimate of the transmitted matrix X and [symbol] is a set of discrete points on MT-dimensional space defined by the pre-determined Grassmann manifold. Due to the discreteness of [symbol] , digital data symbols can be encoded on each discrete point on MT-dimensional space. The difference from the digital modulation is that the discrete point of [symbol] is defined in a multidimensional space in contrast to the complex space (i.e., [symbol] ) of digital modulation schemes such as QAM or PSK.

### Estimation of the Transmitted Matrix H

Given the estimate \hat{X}, the channel matrix H can also be estimated by any channel estimation method that assumes the knowledge of matrix X. For example, with the zero-forcing method the estimate of H is given by:

$$\hat{H} = {( {\hat{X}}^{H} \hat{X} )}^{- 1} {\hat{X}}^{H} Y . \qquad ( 3 )$$

Alternatively, assuming availability of the covariance matrix of the receiver noise Cov(V), the estimate of H with the minimum mean square error (MMSE) estimator is given by:

$$\hat{H} = {( {\hat{X}}^{H} \hat{X} + Cov ( V ) )}^{- 1} {\hat{X}}^{H} Y . \qquad ( 4 )$$

In a similar embodiment, a joint detection of the matrix H and matrix X can be considered.

In some examples, a method to apply Grassmann manifold-based DM-RS for demodulation of transmitted symbols in a NR system is provided. Though in the following example the method is described for an uplink NR transmission from a User Equipment (UE) to a gNodeB (gNB), the method (and other methods of this disclosure) can be applied to any general wireless communication system, including uplink, downlink, sidelink, peer-to-peer, and others, and between any two network nodes. Also, in this example, PUSCH data symbols are sent using a DM-RS, though in other examples any data may be sent using any reference signal or other signal.

Unlike the legacy DM-RS, data such as PUSCH data symbols in examples of this disclosure are superimposed on to the Grassmann based DM-RS, resulting in higher spectral efficiency. Accordingly, consider a User Equipment (UE) with v DM-RS antennas ports serving the gNB. Considering a DM-RS sequence for a port is spread over Nₛ subcarriers, the received signal for the DM-RS ports transmitting over same OFDM symbol but different subcarriers, given by ν̅≤ν, can be given by:

$${Y}_{u} = {X}_{u} {H}_{u} + {V}_{u} , \qquad ( 5 )$$

where Yᵤ∈ [symbol] ^{ν̅}^{_{N}}^{S×ν̅} is the received signal matrix, Xᵤ∈ [symbol] ^{ν̅N}^{ₛ}^{×ν} is block-diagonal matrix such that, Xᵤ=blkdiag(x₁, . . . , x_{ν̅}), where xᵢ∈ [symbol] ^{N}^{ₛ}^{×1} is a Nₛ-dimensional Grassmann manifold [1] transmitted through i^{th} DM-RS port, Hᵤ∈ [symbol] ^{ν̅×ν̅} is the effective channel matrix incorporating the precoding matrix, receiver filter, and the propagation channel matrix, and Vᵤ∈ [symbol] ^{ν̅N}^{ₛ}^{×ν̅} is the noise matrix. At the gNB, the transmitted matrix and the channel matrix can be estimated with methodologies similar to that described above. Note that though the Grassmann manifold is used to describe the joint pilot and data transmission in this example, the general principle applies to any multi-dimensional constellation capable of carrying data symbols (PUSCH/PDSCH) on top of it.

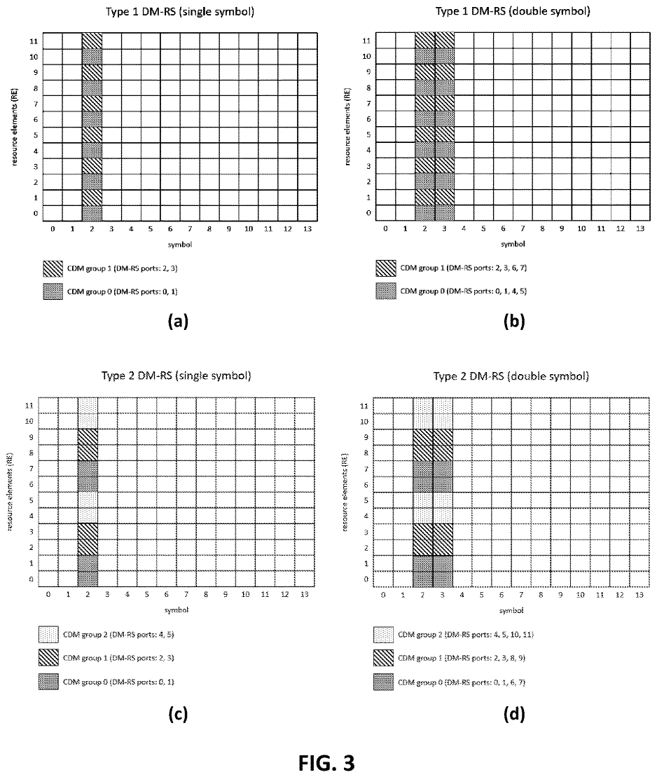

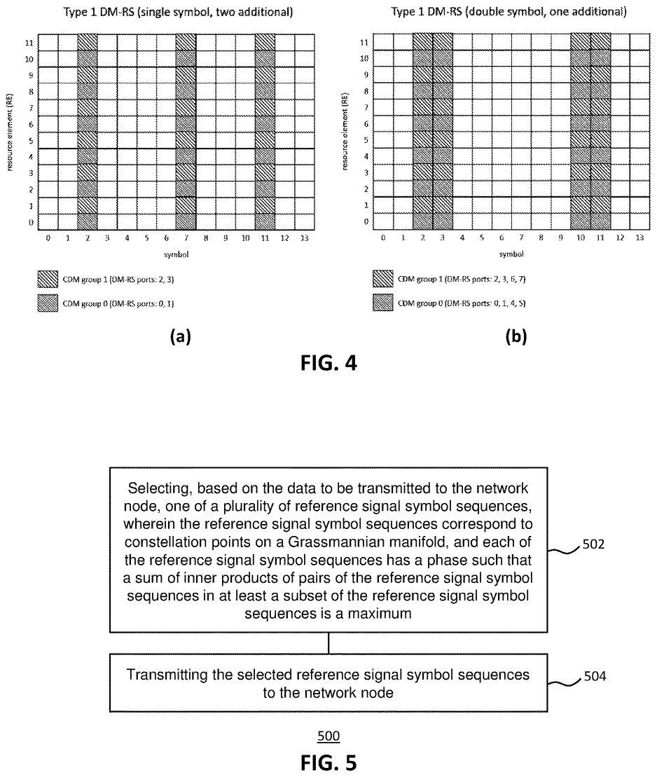

In an example, the Grassmann sequence of each port with length Nₛ can be mapped to resource elements (REs) in a manner similar to legacy Type 1 DM-RS mapping described above, giving two DM-RS ports. Furthermore, in the time-domain, DM-RS can be single symbol or double symbol as shown in FIG. 3(a)-(d). Accordingly, two and four Grassmann based DM-RS ports are possible with one and two-time domain DM-RS symbol, respectively, considering 5=2, as shown in FIG. 7. Specifically, FIG. 7(a) shows an example of a single symbol Type 1 Grassmann DM-RS, and FIG. 7(b) shows an example of a double symbol Type 1 Grassmann DM-RS. In a related example, the Grassmann based DM-RS can be mapped to REs in a Type 2 manner as shown in FIGS. 3(c) and (d) for legacy DM-RS. Note that the Grassmann based DM-RS can be configured with arrangements other that Type 1 and 2, since they can carry PUSCH on top of them.

Though in the above examples, the DM-RS ports per frequency and time resource, i.e., the same subcarriers and time resources (e.g. the same resource element(s)), is limited to one, in some examples code division multiplexing (CDM) using orthogonal cover codes (OCCs) can be mapped on to the Grassmann based DM-RS to transmit more than one DM-RS port using same frequency and time resources in some examples. In another example, where the DM-RS is double symbol such as Type 2 referred to above, one OFDM symbol of the double symbol may be a legacy DM-RS while the other OFDM symbol can be a data-carrying DM-RS according to the present disclosure, such as for example a Grassmann based DM-RS.

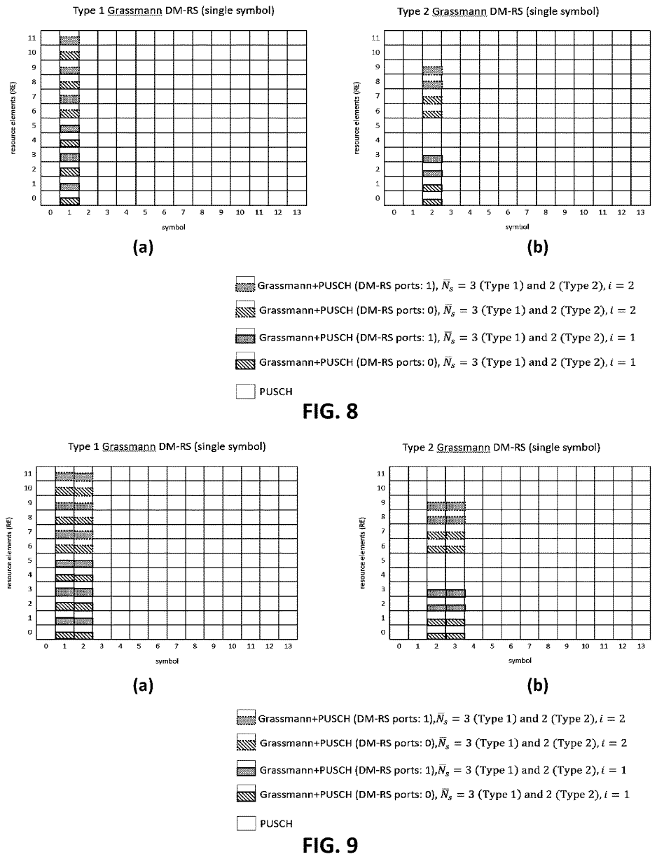

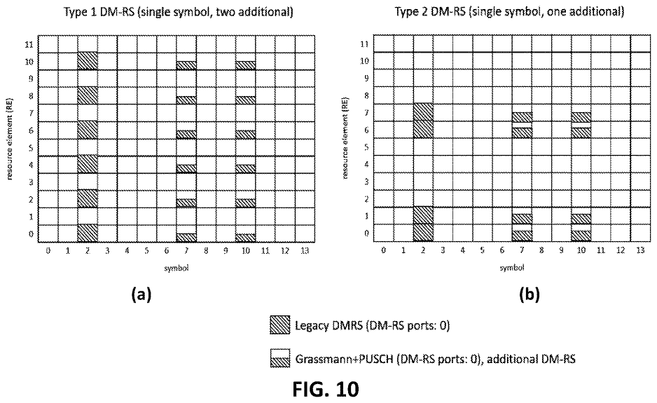

In some examples of this disclosure, the accuracy of channel estimation depends on the frequency selectivity of the channel. For a frequency-flat channel, the channel across the allocated bandwidth is equivalent giving an accurate channel estimation. However, with an increase in the frequency selectivity, the accuracy of the channel estimation may degrade in some examples for a Grassmann based DM-RS. Furthermore, the decoding complexity may be proportional to the Grassmann based DM-RS sequence length Nₛ. Hence, in some examples, Nₛ can be divided into smaller equal lengths Nₛ, such that N̅ₛI=Nₛ, I∈ [symbol] . Accordingly, a shorter N̅ₛ Grassmann based DM-RS sequence is repeated I times to cover Nₛ subcarriers, as suggested above with reference to the method 500 or 600. This may for example allow estimation over a smaller bandwidth with lower frequency selectivity while having a lower complexity for each of the smaller sequences. As an example, the above embodiment is illustrated in FIG. 8, which shows an example of repetition of a Grassmann based DM-RS sequence in the frequency domain. Specifically, FIG. 8(a) shows an example of the Grassmann based DM-RS sequence divided into groups for a DM-RS port, with each group occupying N̅ₛ=3 subcarriers for Type 1 arrangement, and FIG. 8(b) shows N̅ₛ=2 subcarriers for Type 2 arrangement.

In a related example, if more accurate channel estimation is needed, a Grassmann based DM-RS sequence can be sent over N̅ₛ subcarriers and two or more consecutive OFDM symbols, resulting in modification of Yᵤ∈ [symbol] ^{ν̅N}^{ₛ}^{N}^{ₜ}^{×ν} and:

$${X}_{u} = ( \begin{matrix}blk diag ( {x}_{1}^{1} , … , x \frac{1}{υ} ) \\ blk diag ( {x}_{1}^{2} , … , x \frac{2}{υ} ) \\ ⋮ \\ blk diag ( {x}_{1}^{T} , … , x \frac{T}{υ} )\end{matrix} ) , \qquad ( 6 )$$

where T is the number of consecutive OFDM symbols and

$$x \frac{1}{υ} ∈ {ℂ}^{{N}_{s} \times 1}$$

is a Nₛ-dimensional Grassmann manifold [1] transmitted through i^{th} DM-RS port at t^{th} OFDM symbol. This can allow more accurate channel estimation of a high frequency selective channel by taking advantage of time domain. An example of this is illustrated in FIG. 8, where the Grassmann based DM-RS sequence is divided into groups for a DM-RS port while utilizing T=2 consecutive OFDM symbols.

Specifically, FIG. 8(a) shows an example of a single symbol Type 1 Grassmann DM-RS, and FIG. 8(b) shows an example of a single symbol Type 2 Grassmann DM-RS. This example relates to front-loaded PUSCH (i.e., PUSCH mapping type A) of duration 14 symbols. The Grassmann based DM-RS sequence is divided into groups for a DM-RS port, where each group occupies N̅ₛ=3 subcarriers and N̅ₛ=2 subcarriers for Type 1 and Type 2 kind of arrangement, respectively. The figures show two such groups, i.e., i=1, 2, for a resource block.

The frequency and time domain starting positions of DM-RS according to this disclosure, such as for example a Grassmann based DM-RS or any other example of a data-carrying DM-RS, can follow the configuration similar to legacy DM-RS as described above. In low-Doppler scenarios, similar to legacy DM-RS, one Grassmann based DM-RS symbol may be sufficient, whereas, in high-Doppler scenarios, additional Grassmann based DM-RS symbols may be useful or needed in some examples.

While legacy DM-RS can have the advantage of higher channel estimation accuracy and low decoding complexity in some examples, the DM-RS according to this disclosure (e.g. Grassmann based DM-RS) may impart additional spectral efficiency by superimposing PUSCH onto the Grassmann based DM-RS sequence. Accordingly, in some examples, both legacy DM-RS and DM-RS according to this disclosure can be used (e.g. in a resource block, slot, mini-slot, subframe and/or frame) to achieve advantages of both the legacy DM-RS and the DM-RS according to this disclosure. For example, in a high doppler scenario, a first DM-RS symbol in a resource block can be a legacy DM-RS, and a subsequent DM-RS can be a DM-RS according to this disclosure, such as for example Grassmann based DM-RS. An example is shown in FIG. 9. Specifically, FIG. 9(a) shows an example where one additional DM-RS position is configured for Type 1, and FIG. 9(b) shows an example where one additional DM-RS position is configured for Type 2, for a single symbol DM-RS. This example relates to front-loaded PUSCH (i.e., PUSCH mapping type A) of duration 14 symbols. The first DM-RS symbols use the legacy sequence, where the two additional DM-RS symbols in the slot use Grassmann based DM-RS.

In some examples, the use of either or both legacy DM-RS and/or DM-RS according to this disclosure can be signaled to a network node, such as a UE, by another network node, such as a gNB. This may be done for example through higher layer RRC signaling by including additional information elements in the DM-RS-config parameter structure (discussed in Section 2.1.2.1). Examples of additional parameters may include one or more of:
‘DM-RS-Sequence’ can signal the use of legacy DM-RS, DM-RS according to this disclosure, or both,
‘DM-RS-AdditionalSequence’ signals a bit sequence equal to number of DM-RS symbols in a slot to indicate either the use of legacy DMRS or DM-RS according to this disclosure in each DM-RS symbol position, where position of legacy DM-RS and/or DM-RS according to this disclosure can be signaled by the gNB through RRC connection using DM-RS-AdditionalPosition information element in DM-RS-config parameter structure.

In a related example, where Phase Tracking Reference Signal (PT-RS) is configured in a slot, the PT-RS can be signaled to occupy the subcarriers and OFDM symbols such that they do not overlap with the DM-RS (e.g. DM-RS according to this disclosure such as a Grassmann based DM-RS) if used in the slot. Alternatively, the DM-RS can be configured not to overlap with the PT-RS REs.

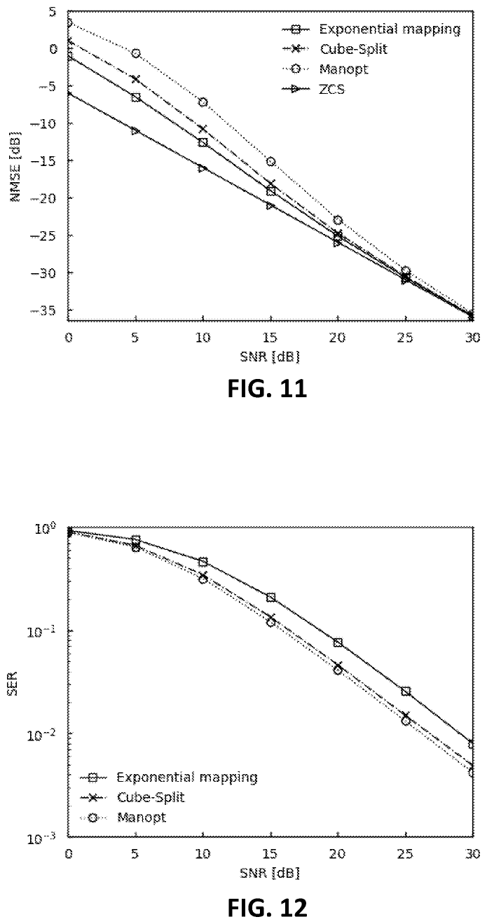

A challenge in constructing Grassmann constellations for examples of Grassmann-based reference signal and data transmission as disclosed herein is a trade-off between estimation performance of the reference signal X and the channel H. More specifically, for example, normalized mean square error (NMSE) and symbol error rate (SER) performance of different Grassmann constellations when used for data transmission are shown in FIGS. 11 and 12 respectively, where the NMSE and SER performance is shown against Signal to Noise Ration (SNR). The constellations for which performance is shown are exponential mapping [1], Cube-Split [2] and Manopt, while the NMSE performance of the Zadoff-Chu sequence (ZCS) is included as a baseline in FIG. 11. Note that the ZCS is a conventional reference signaling methodology and may not send data, unlike the Grassmann sequences used as disclosed herein; therefore, it may be regarded for example as a channel estimation performance baseline. The ManOpt constellation is a numerically optimized Grassmann constellation, for which a publicly available optimization solver “Pymanopt” was used to demonstrate its performance.

Comparing the SER and NMSE performance shown in FIGS. 11 and 12, it can be seen that there is a clear trade-off between the SER and NMSE. In other words, the exponential mapping is the best of the illustrated methods in terms of channel estimation performance while being the worst in terms of the SER performance. Similarly, the Cube-Split and ManOpt method are shown to be better than the exponential mapping in terms of SER at the cost of having a worse channel estimation performance. Given the above, a Grassmann constellation methodology to tackle this trade-off, i.e. to improve the channel estimation NMSE performance while maintaining SER performance, is the focus of example embodiments of this disclosure.

Disclosed methodologies propose to improve a Grassmann constellation by optimizing the phase of each codeword of the Grassmann constellation, and to utilize such a constellation with certain properties in data transmission, such as in the methods 500 and 600 described above. The following provides an example of a methodology for constructing or modifying a Grassmann-based constellation according to embodiments of this disclosure.

For example, let us define C={X₁, X₂, . . . , X_{L}} as a Grassmann constellation (i.e., a set of codewords X₁, X₂, . . . , X_{L}), where Xₗ∈ [symbol] ^{T×M} with l∈{1, 2, . . . , L} is a codeword matrix as shown in equation (1). Furthermore, let us define Cₚ={x₁ₚ, x₂ₚ, . . . , x_{Lp}} as a set of vectors comprising the p-th column vectors of Xₗ for all l∈{1, 2, . . . , L} and p∈{1, 2, . . . , M}, and Eₚ= {e^{jθ}^{₁ₚ}, . . . , e^{jθ}^{_{Lp}}} as a phase alignment coefficient set associated with Cₚ, whose element (i.e., θₗₚ) is a variable to be optimized.

The channel estimation accuracy (i.e., NMSE) can be written as:

$$NMSE = \frac{E [ {‖ \hat{H} - H ‖}_{F}^{2} ]}{E [ {‖ H ‖}_{F}^{2} ]} , \qquad ( 5 )$$

where the numerator computes the actual Euclidean distance between the estimated channel matrix and the true channel matrix, and the denominator is for normalization purposes.

Assuming an estimate \hat{X} of the reference signal X as shown above, the nominator can be expressed after equalization as:

$${‖ \hat{H} - H ‖}_{F}^{2} = {‖ ( {\hat{X}}^{H} X - {I}_{M} ) H - {V}^{′} ‖}_{F}^{2} , \qquad ( 6 )$$

where V′ is the effective noise matrix after equalization and we utilized the fact that \hat{X}^{H}\hat{X}=I due to the property of Grassmann manifold.

From the above equation, it is evident that the NMSE is minimized if and only if (\hat{X}^{H}X−I_{M}) is minimized (i.e., \hat{X}^{H}X becomes the identity matrix), which is the case where the estimate \hat{X} matches the transmitted reference signal X. It is, however, inevitable that the estimate \hat{X} may differ from the transmitted reference signal X (e.g. due to noise). In case \hat{X} differs from reference signal X, the coefficient \hat{X}^{H}X may not be the identity matrix, resulting in degradation in NMSE.

In such case, however, the NMSE degradation can be mitigated by optimizing the phase of at least some Grassmann codewords, constellation points, or associated symbol sequences, such that \hat{X}^{H}X becomes as close to the identity matrix I_{M} as possible, which is the main idea of example embodiments of this disclosure. In other words, in some examples, the phase alignment coefficients may be optimized such that the inner product between one or more pairs of Grassmann codewords/points/symbol sequences in the Grassmann constellation set Cₚ becomes 1 (i.e., diagonal element of the identity matrix) or closer to 1 (e.g. maximized).

Without loss of generality, we assume

$${‖ {x}_{lp} ‖}_{F}^{2} = 1 with l ∈ \{ 1 , 2 , … , L \} .$$

To this end, the phase alignment coefficients Eₚ for all p may be optimized in some examples such that the sum of all possible inner products is maximized, i.e.:

$${max}_{{E}_{p}} {{\sum }_{l = 1}}^{L} {{\sum }_{i \neq l}}^{L} Re \{ {( {x}_{lp} {e}^{j {θ}_{lp}} )}^{H} ( {x}_{ip} {e}^{j {θ}_{ip}} ) \} \qquad ( 7 )$$

which can be solved via, e.g., sequential quadratic programming solvers such as SLSQP. Finally, the optimized phase alignment coefficients may be multiplied with the original Grassmann constellation set, or set of points, codewords or symbol sequences. For example, the phase-aligned Grassmann constellation subset may be given by

$${C}_{p}^{′} = \{ {x}_{1 p} {e}^{j {θ}_{1 p}} , … , {x}_{lp} {e}^{j {θ}_{lp}} , … , {x}_{Lp} {e}^{j {θ}_{Lp}} \} .$$

In some examples, the phase-aligned Grassmann C′ is constructed by merging the subsets

$${C}_{p}^{′}$$

for all p.

The phase alignment in some examples does not change the geometrical structure of the original Grassmann constellation, so that the NMSE performance is improved while maintaining the same symbol estimation error compared to the original Grassmann constellation. In some examples, the phase-aligned Grassmann constellation may be computed offline, and may for example be signaled between both the transmitter and receiver prior to the channel and data communication. Alternatively, for example, the optimized phase-aligned Grassmann constellation may be provided in a specification text, agreed explicitly via bilateral vendor agreements, or otherwise predefined. For example, in 5G/6G communication for downlink (DL), such a phase-aligned or phase-optimized Grassmann constellation can be part of the 3GPP specification and/or agreed explicitly via bilateral vendor agreements, where the phase-aligned Grassmann constellation is computed by either of the transmitter or receiver vendor or jointly by vendors. The gNB can then signal the use of such a constellation for a reference signal (e.g. DMRS) through RRC signaling or Downlink Control Information (DCI).

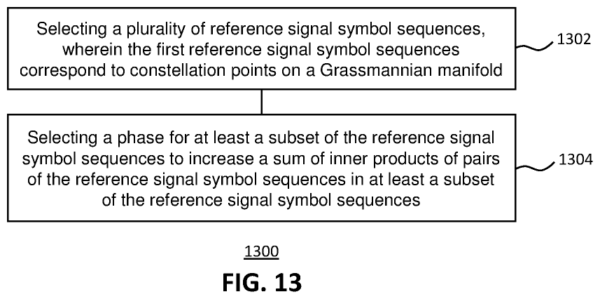

FIG. 13 is a flow chart of an example of a method 1300 of determining a plurality of reference signal symbol sequences. The method 1300 comprises, in step 1302, selecting a plurality of reference signal symbol sequences, wherein the first reference signal symbol sequences correspond to constellation points on a Grassmannian manifold. Next, step 1304 of the method 1300 comprises selecting a phase for at least a subset of the reference signal symbol sequences to increase a sum of inner products of pairs of the reference signal symbol sequences in at least a subset of the reference signal symbol sequences. Thus, in some examples the method 1300 may comprise a method of modifying reference signal symbol sequences. The reference signal symbol sequences for which the phases are selected may be used in embodiments of this disclosure, such as for example in the methods 500 and 600 described above. For example, the method 1300 may include transmitting one or more of the reference signal symbol sequences, and/or receiving one or more of the reference signal symbol sequences.

An increase in the sum of inner products of the pairs of sequences in the subset may in some examples improve NMSE performance while maintaining or substantially maintaining SER performance. In some examples, the method 1300 may comprise selecting the phase for the at least a subset of the reference signal symbol sequences to maximize the sum of inner products of pairs of the reference signal symbol sequences in the at least a subset of the reference signal symbol sequences.

The method 1300 may in some examples comprise sending information identifying the plurality of modified reference signal symbol sequences (or their phases) to a transmitter for transmitting one or more of the second reference signal symbol sequences. Additionally or alternatively, the method 1300 may in some examples comprise sending information identifying the plurality of modified reference signal symbol sequences (or their phases) to a receiver for receiving one or more of the second reference signal symbol sequences. Thus for example a transmitter and receiver may have knowledge of the reference signal symbol sequences through sharing the sequences or their phases.

Each reference signal symbol sequence may in some examples be associated with a different value for data bits. For example, there may be 2^{B} reference signal symbol sequences and/or 2^{B} constellation points with B being the number of data bits encoded by each reference signal symbol sequence. Additionally or alternatively, for example, there may be 2^{B} constellation points with B being the number of data bits encoded by each constellation point. The Grassmann manifold may in some examples be at least a 2n dimension manifold, where n is the number of reference signal symbols in each reference signal symbol sequence.

The reference signal symbol sequences may be for example pilot signals or demodulation reference signals (DM-RS).

In some examples, the method 1300 may comprise selecting the phase for at least a subset of the reference signal symbol sequences to maximize the sum of inner products of pairs of the reference signal symbol sequences in the at least a subset of the reference signal symbol sequences.

Next, the performance of example embodiments of this disclosure is considered. The presented results can, however, be extended to many different scenarios and parameters, and the disclosed methodologies may not be limited to the cases simulated herein.

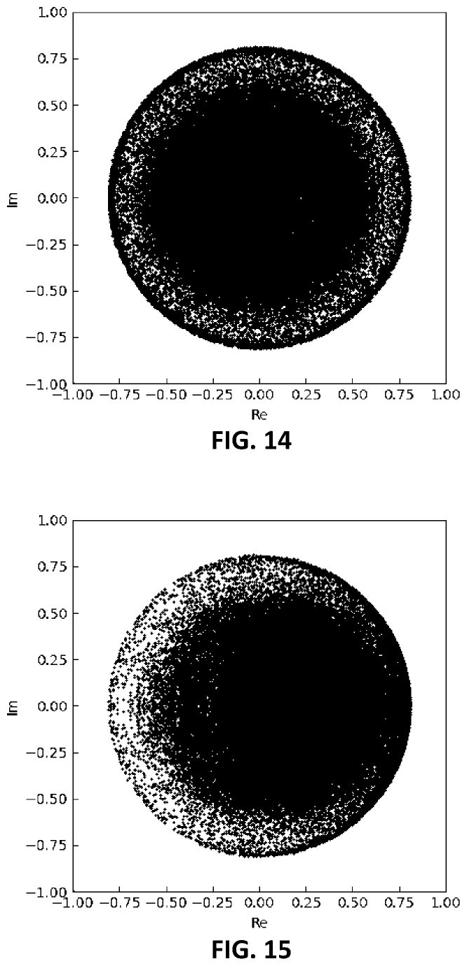

FIG. 14 shows a scatter plot of examples of the inner product of different Grassmann codeword pairs (i.e., the inner product between xₗₚ and xᵢₚ with i≠l) for the case of a non-phase-aligned Grassmann constellation (e.g. the Grassmann constellation obtained by the ManOpt method without any change). As shown in FIG. 14, the inner product is scattered uniformly and most inner products are far from 1, which results in a worse NMSE performance as explained in equation (6) above and demonstrated in FIG. 12. That is, the ManOpt method provided reference signal symbol sequences that had the worst NMSE performance of the examined methods.

In contrast, FIG. 15 shows a scatter plot of examples of the inner product of different Grassmann codeword pairs (i.e., the inner product between xₗₚ and xᵢₚ with i≠l) for the case of a phase-aligned ManOpt Grassmann constellation. For example, the ManOpt Grassmann constellation (or the associated reference signal symbol sequences) may be modified or phases determined according to the method 1300 shown in FIG. 13, and/or the reference symbol signal sequences may have the properties indicated in the methods 500 and 600, i.e. each of the reference signal symbol sequences has a phase such that a sum of inner products of pairs of the reference signal symbol sequences in at least a subset of the reference signal symbol sequences is a maximum. In particular, the sum of inner products is a maximum for the symbol sequences as a whole in the example shown in FIG. 15. As shown in FIG. 15, the scatter points tend to be as close to 1 as possible, from which a better NMSE performance can be expected as compared to the example shown in FIG. 14.

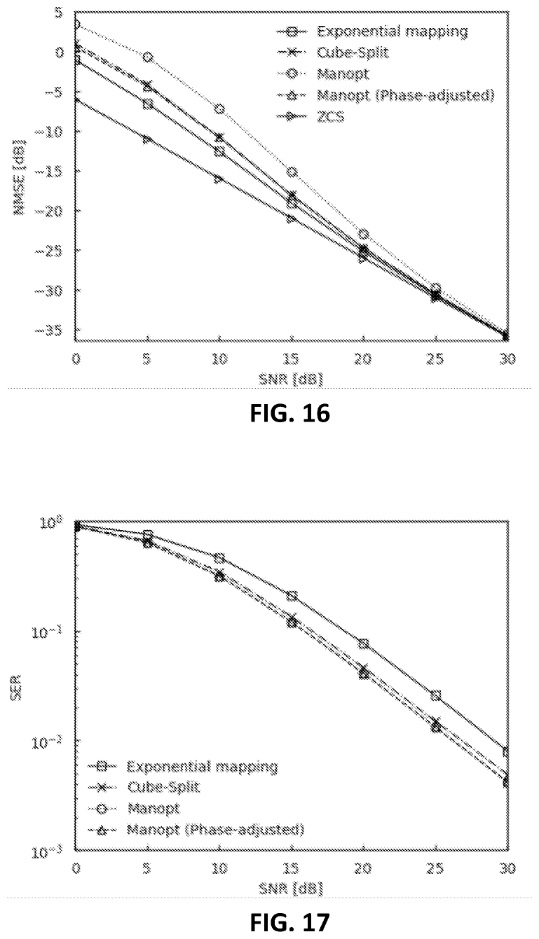

FIG. 16 shows another example of normalized mean square error (NMSE) performance of different Grassmann constellations with respect to SNR when used for data transmission. The same methodologies as for FIG. 11 are presented, along with a phase adjusted ManOpt method, e.g. phase-adjusted according to the method 1300 of FIG. 13 and/or to have the properties indicated in the methods 500 and 600. The phase-aligned ManOpt constellation has an improved NMSE performance compared with the non-phase aligned ManOpt constellation. This is because the phase alignment tends to make all possible inner products of any codeword pair as close to 1 as possible (e.g. maximized sum of inner products of all codeword pairs).

FIG. 17 shows another example of symbol error rate (SER) performance of different Grassmann constellations when used for data transmission. The same methodologies as for FIG. 12 are presented, along with a phase adjusted ManOpt method, e.g. phase-adjusted according to the method 1300 of FIG. 13 and/or to have the properties indicated in the methods 500 and 600. It can be seen that the SER performance of the phase aligned Manopt constellation/symbol sequences is the same as the non-phase aligned Manopt method.

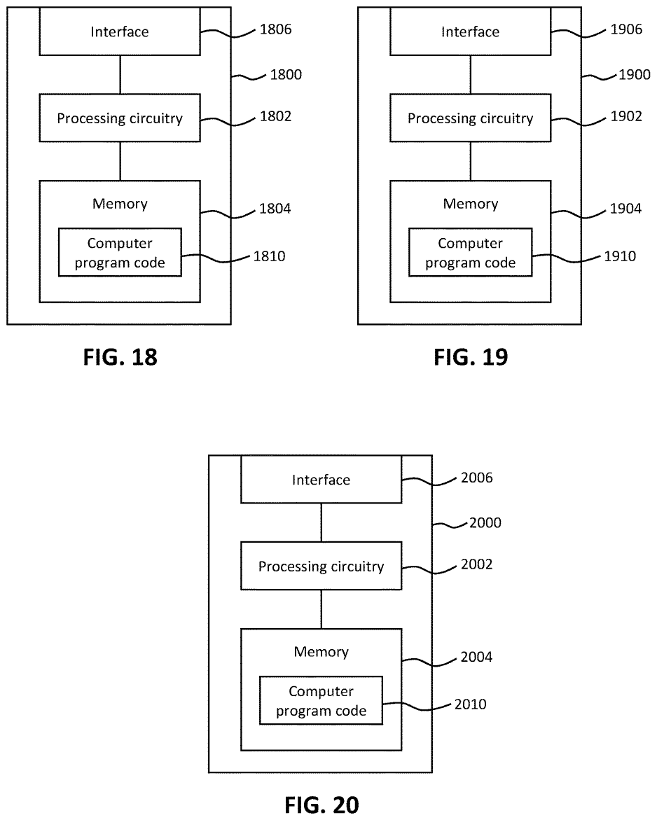

FIG. 18 is a schematic of an example of an apparatus 1800 for transmitting data to a network node. The apparatus 1800 comprises processing circuitry 1802 (e.g. one or more processors) and a memory 1804 in communication with the processing circuitry 1802. The memory 1804 contains instructions, such as computer program code 1810, executable by the processing circuitry 1802. The apparatus 1800 also comprises an interface 1806 in communication with the processing circuitry 1802. Although the interface 1806, processing circuitry 1802 and memory 1804 are shown connected in series, these may alternatively be interconnected in any other way, for example via a bus.

In one embodiment, the memory 1804 contains instructions executable by the processing circuitry 1802 such that the apparatus 1800 is operable/configured to select, based on the data to be transmitted to the network node, one of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum; and transmit the selected reference signal symbol sequences to the network node. In some examples, the apparatus 1800 is operable/configured to carry out the method 500 described above with reference to FIG. 5.

FIG. 19 is a schematic of an example of an apparatus 1900 for receiving data from a network node. The apparatus 1900 comprises processing circuitry 1902 (e.g. one or more processors) and a memory 1904 in communication with the processing circuitry 1902. The memory 1904 contains instructions, such as computer program code 1910, executable by the processing circuitry 1902. The apparatus 1900 also comprises an interface 1906 in communication with the processing circuitry 1902. Although the interface 1906, processing circuitry 1902 and memory 1904 are shown connected in series, these may alternatively be interconnected in any other way, for example via a bus.

In one embodiment, the memory 1904 contains instructions executable by the processing circuitry 1902 such that the apparatus 1900 is operable/configured to receive, from the network node, a reference signal symbol sequence of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum; and determine, based on the reference signal symbol sequence, the data transmitted by the network node. In some examples, the apparatus 1900 is operable/configured to carry out the method 600 described above with reference to FIG. 6.

FIG. 20 is a schematic of an example of an apparatus 2000 for determining a plurality of reference signal symbol sequences. The apparatus 2000 comprises processing circuitry 2002 (e.g. one or more processors) and a memory 2004 in communication with the processing circuitry 2002. The memory 2004 contains instructions, such as computer program code 2010, executable by the processing circuitry 2002. The apparatus 2000 also comprises an interface 2006 in communication with the processing circuitry 2002. Although the interface 2006, processing circuitry 2002 and memory 2004 are shown connected in series, these may alternatively be interconnected in any other way, for example via a bus.

In one embodiment, the memory 2004 contains instructions executable by the processing circuitry 2002 such that the apparatus 2000 is operable/configured to select a plurality of reference signal symbol sequences, wherein the first reference signal symbol sequences correspond to constellation points on a Grassmannian manifold; and select a phase for at least a subset of the reference signal symbol sequences to increase a sum of inner products of pairs of the reference signal symbol sequences in at least a subset of the reference signal symbol sequences. In some examples, the apparatus 2000 is operable/configured to carry out the method 1300 described above with reference to FIG. 13.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

### REFERENCES

1. I. Kammoun, A. M. Cipriano, J. C. Belfore, “Non-coherent codes over the Grassmannian,” IEEE Transactions on Wireless Communications, vol. 6, no. 10, October 2007.
2. K. H. Ngo, A. Decurninge, M. Guillaud, and S. Yang, “Transmitter and receiver communication apparatus for non-coherent communication”, United States Patent U.S. Pat. No. 11,258,649B2, February 2022.

1-58. (canceled)

59. A method of transmitting data to a network node, the method comprising:
selecting, based on the data to be transmitted to the network node, one of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum; and
transmitting the selected reference signal symbol sequences to the network node.

60. The method of claim 59, wherein each reference signal symbol sequence is associated with a different value for the data.

61. The method of claim 59, wherein selecting one of a plurality of reference signal symbol sequences comprises selecting a reference signal symbol sequence from 2\hat{ }B reference signal symbol sequences and/or 2\hat{ }B constellation points with B being the number of data bits encoded by each reference signal symbol sequence.

62. The method of claim 59, wherein the Grassmann manifold is at least a 2n dimension manifold, where n is the number of reference signal symbols in each reference signal symbol sequence.

63. The method of claim 59, wherein the method further comprises transmitting at least one additional reference signal symbol sequence to the network node, wherein the at least one additional reference signal symbol sequence corresponds to a legacy reference signal.

64. The method of claim 59, wherein the transmitted selected reference signal symbol sequence is a pilot signal or a demodulation reference signal (DM-RS).

65. A method of receiving data from a network node, the method comprising:
receiving, from the network node, a reference signal symbol sequence of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum; and
determining, based on the reference signal symbol sequence, the data transmitted by the network node.

66. The method of claim 65, wherein each reference signal symbol sequence is associated with a different value for the data.

67. The method of claim 65, wherein there are 2\hat{ }B reference signal symbol sequences and/or 2\hat{ }B constellation points with B being the number of data bits encoded by each reference signal symbol sequence.

68. The method of claim 65, wherein the Grassmann manifold is at least a 2n dimension manifold, where n is the number of reference signal symbols in each reference signal symbol sequence.

69. The method of claim 65, wherein the reference signal symbol sequence is a pilot signal or a demodulation reference signal (DM-RS).

70. An apparatus for transmitting data to a network node, the apparatus comprising:
processing circuitry; and
memory, the memory containing instructions executable by the processing circuitry, wherein the apparatus is configured to perform a process comprising:
selecting, based on the data to be transmitted to the network node, one of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum; and
transmitting the selected reference signal symbol sequences to the network node.

71. The apparatus of claim 70, wherein each reference signal symbol sequence is associated with a different value for the data.

72. The apparatus of claim 70, wherein selecting one of a plurality of reference signal symbol sequences comprises selecting a reference signal symbol sequence from 2\hat{ }B reference signal symbol sequences and/or 2\hat{ }B constellation points with B being the number of data bits encoded by each reference signal symbol sequence.

73. The apparatus of claim 70, wherein the Grassmann manifold is at least a 2n dimension manifold, where n is the number of reference signal symbols in each reference signal symbol sequence.

74. The apparatus of claim 70, wherein the process further comprises transmitting at least one additional reference signal symbol sequence to the network node, wherein the at least one additional reference signal symbol sequence corresponds to a legacy reference signal.

75. An apparatus for receiving data from a network node, the apparatus comprising:
processing circuitry; and
memory, the memory containing instructions executable by the processing circuitry, wherein the apparatus is configured to perform a process comprising:
receiving, from the network node, a reference signal symbol sequence of a plurality of reference signal symbol sequences, wherein the reference signal symbol sequences correspond to constellation points on a Grassmannian manifold, and each of the reference signal symbol sequences has a phase such that a sum of inner products of pairs of the reference signal symbol sequences in at least a subset of the reference signal symbol sequences is a maximum; and
determining, based on the reference signal symbol sequence, the data transmitted by the network node.

76. The apparatus of claim 75, wherein each reference signal symbol sequence is associated with a different value for the data.

77. The apparatus of claim 75, wherein there are 2\hat{ }B reference signal symbol sequences and/or 2\hat{ }B constellation points with B being the number of data bits encoded by each reference signal symbol sequence.

78. The apparatus of claim 75, wherein the Grassmann manifold is at least a 2n dimension manifold, where n is the number of reference signal symbols in each reference signal symbol sequence.
